(19) United States
(12) Patent Application Publication
(10) Pub. No.: US 2025/0129583 A1
(43) Pub. Date: Apr. 24, 2025

(54) PULL-OUT FAUCET

(71) Applicants: Xingui ZHANG, Fujian (CN); Yihui CHEN, Fujian (CN); Mouyong LIN, Fujian (CN)

(72) Inventors: Xingui ZHANG, Fujian (CN); Yihui CHEN, Fujian (CN); Mouyong LIN, Fujian (CN)

(21) Appl. No.: 18/909,983

(22) Filed: Oct. 9, 2024

(30) Foreign Application Priority Data
Oct. 18, 2023 (CN) 202311350391.5

(51) Int. Cl. E03C 1/04; E03C 1/02; F16K 31/365

(52) U.S. Cl. CPC E03C 1/0404; F16K 31/365; E03C 2001/026; E03C 2001/0415

(57) ABSTRACT

A pull-out faucet including a faucet body, a spray head whose one end is connected to the faucet body, a pull-out pipe, and a non-electrically-driven water outlet assembly disposed in the faucet body and having a movable plug; another end of the pull-out pipe is in communication with a water outlet end of the non-electrically-driven water outlet assembly. The spray head drives a driving mechanism on the pull-out pipe to move up and down so as to be positioned corresponding to or away from the movable plug whose movements will open and close a water path. No electricity is required and so the pull-out faucet is widely applicable and has a low cost of use.

### BACKGROUND OF THE INVENTION

The present invention relates to the technical field of kitchen and bathroom faucets, and in particular, to a pull-out faucet.

A spray head of a pull-out faucet can be pulled to different positions to meet different water demands, and therefore, the pull-out faucet is convenient to use and widely used. A conventional spray head of a pull-out faucet is provided on a faucet body in a pull-out manner by connecting a pull-out hose to a water outlet pipe, and a counter weight or a counter weight component is usually fixed onto the pull-out hose and mounted below a countertop. The pull-out faucet usually utilizes a handle to operate a valve core to control water output; when the pull-out faucet needs to be pulled out to perform cleaning or washing purpose, the pull-out hose is pulled out, and the valve core is opened to output water. When the user releases the pulled-out spray head, the spray head can be automatically restored to an original position on the pull-out faucet through the counter force provided by the counter weight or the counter weight component.

To output water more conveniently, there is a kind of faucet that may also enable water output by simply pulling out the spray head. A magnetic reed switch is used in this kind of faucet to control water output, so that when the spray head is pulled out, water can be directly output without operating a handle. A conventional magnetic reed switch operates generally in the following way in a pull-out faucet: when the pull-out hose is pulled out, a magnetic reed switch sensor probe stops operating, and so the magnetic reed switch controls a solenoid valve to open so as to output water. When the pull-out hose resets to its original position on the pull-out faucet, the magnetic reed switch controls the solenoid valve to close to stop outputting water, and the magnetic reed switch sensor probe resumes its operation. This kind of intelligent control faucet is disclosed in, for example, CN203927007U (application number CN201420331760.6).

However, various electronic components such as a sensor and a solenoid valve are required inside this kind of pull-out faucet. This leads to high production and manufacturing costs of the faucet. In addition, the faucet needs to be powered during use, thereby consuming electrical energy and causing high costs of use.

### BRIEF SUMMARY OF THE INVENTION

In view of the aforesaid disadvantages in the prior arts, it is an object of the present invention to provide a pull-out faucet that enables water output through the action of simply pulling out the spray head be achievable by non-electrical components, and hence possesses the advantages of low product costs and low costs of use.

To fulfill the above object of the present invention, the present invention provides the following technical solutions:
A pull-out faucet, comprising a faucet body, a spray head, a pull-out pipe, and a non-electrically-driven water outlet assembly;
the spray head is detachably mounted to one end of the faucet body;
the pull-out pipe is movably inserted into the faucet body and is movable axially in the faucet body; one end of the pull-out pipe communicates with the spray head, and another end of the pull-out pipe is in communication with a water outlet end of the non-electrically-driven water outlet assembly;
the non-electrically-driven water outlet assembly is provided in the faucet body; the non-electrically-driven water outlet assembly comprises a valve body, a water inlet end provided on the valve body for water inlet, the water outlet end provided on the valve body, and a movable plug for opening and closing a water path between the water inlet end and the water outlet end;
a driving mechanism is provided on an outer side wall of the pull-out pipe; the spray head, when being pulled out from the faucet body, drives the pull-out pipe and the driving mechanism to move to a position corresponding to the movable plug and thus interact with the movable plug in a way that the driving mechanism drives the movable plug to move to open the water path; the spray head, when being reset onto the faucet body, drives the pull-out pipe and the driving mechanism to move away from the movable plug so that the movable plug is driven to move oppositely to close the water path.

Further, the movable plug is mounted in the valve body and movable in and out of the valve body; a movable plug elastic member is disposed between the movable plug and the valve body; the movable plug elastic member biases the movable plug to close the water path, an outer end of the movable plug is biased by the movable plug elastic member to extend out of the valve body facing to the pull-out pipe; the driving mechanism comprises a driving part radially protruding from the outer side wall of the pull-out pipe; when the driving mechanism interacts with the movable plug, the driving part abuts against the movable plug to drive the movable plug to overcome a biasing force of the movable plug elastic member so as to drive the movable plug to move into the valve body away from the pull-out pipe and thus open the water path.

Further, the movable plug is axially movable within the valve body; a movable plug elastic member is disposed between the movable plug and the valve body; the movable plug elastic part biases the movable plug to close the water path; the driving mechanism comprises a driving part; both the driving part and the movable plug are made of materials that magnetically attract each other; when the driving part approaches the movable plug, the driving part magnetically attracts the movable plug to move so that the movable plug overcomes an elastic force of the movable plug elastic part and moves to open the water path.

Further, the valve body of the non-electrically-driven water outlet assembly comprises a valve body seat and a valve body side cover which are side-by-side detachably connected to each other; a valve body cavity is formed between the valve body side cover and the valve body seat; a cavity inlet in communication with the water inlet end is provided on the valve body cavity, and a cavity outlet in communication with the water outlet end is provided on one side of the cavity inlet of the valve body cavity; the movable plug is axially movable in and out of the valve body cavity; an inner end of the movable plug is used for opening and closing the cavity outlet, and an outer end of the movable plug facing to the pull-out pipe is driven by the driving part to drive the inner end to move.

Further, a pilot valve is provided in the water path of the valve body; the pilot valve comprises a main valve and a guide valve; the main valve has a left cavity and a right cavity separated by a diaphragm; the left cavity is provided with a cavity outlet that is capable of allowing communication between the water inlet end and the water outlet end, and the right cavity communicates with the guide valve; a diaphragm elastic member is provided in the right cavity, the diaphragm elastic member applies an elastic force against the diaphragm to bias the diaphragm to removably block the cavity outlet; a communication hole communicating the left cavity and the right cavity is provided on the diaphragm at a position on the diaphragm corresponding to a point outside a periphery of the cavity outlet; the movable plug is movable to open and close a pilot hole of the guide valve to allow the guide valve to allow and disallow communication between the right cavity of the main valve and the water outlet end, thereby controlling the diaphragm to open and close the cavity outlet to open and close the water path.

Further, the main valve and the guide valve of the pilot valve are arranged side by side and are coaxially provided on one side of the pull-out pipe which is movable up and down, and the guide valve is disposed more proximal to the pull-out pipe than the main valve; the pilot hole of the guide valve is located between a guide valve cavity of the guide valve and the right cavity, and a guide valve hole is formed between the guide valve cavity and the water outlet end; the movable plug is movable left and right in the guide valve cavity.

Further, the valve body of the non-electrically-driven water outlet assembly comprises a valve body seat and a valve body side cover which are side-by-side detachably connected to each other;
the left cavity and the right cavity of the main valve are formed between the valve body side cover and the valve body seat; a periphery of the diaphragm is fixed between the valve body side cover and the valve body seat; the left cavity is provided with a cavity inlet in communication with the water inlet end, and a middle part of the left cavity is provided with the cavity outlet in communication with the water outlet end; the valve body side cover is more proximal to the pull-out pipe than the valve body seat and is provided with the guide valve cavity;
an inner end of the movable plug is movable to open and close a pilot hole of the guide valve cavity; an outer end of the movable plug more proximal to the pull-out pipe than the inner end is capable to be driven by the driving part so as to move the inner end of the movable plug.

Further, the main valve and the guide valve of the pilot valve are arranged in parallel in an up-down direction corresponding to a moving direction of the pull-out pipe in the pull-out faucet; the pilot hole of the guide valve is located between the guide valve cavity and the water outlet end, and a guide valve hole is formed between the guide valve cavity and the right cavity of the main valve; the movable plug is axially movable left and right in the guide valve cavity.

Further, the valve body of the non-electrically-driven water outlet assembly comprises a valve body seat, a valve body side cover, and a guide valve cover plate, where the valve body side cover and the guide valve cover plate are detachably connected side-by-side with the valve body seat;
a left cavity and a right cavity of the main valve are formed between the valve body side cover and the valve body seat; a periphery of the diaphragm is fixed between the valve body side cover and the valve body seat; the left cavity is provided with the cavity inlet in communication with the water inlet end, and a middle part of the left cavity is provided with a cavity outlet in communication with the water outlet end; the guide valve cover plate is located below the valve body side cover and adjacent to the pull-out pipe; the guide valve cavity is formed between the guide valve cover plate and the valve body seat;
an inner end of the movable plug is movable to open and close a pilot hole of the guide valve cavity; an outer end of the movable plug more proximal to the pull-out pipe than the inner end is capable to be driven by the driving part so as to move the inner end of the movable plug.

Further, an outer end of the movable plug extends out of the valve body and faces to the pull-out pipe; the driving mechanism comprises a driving part radially protruding from an outer side wall of the pull-out pipe, and when the driving mechanism interacts with the movable plug, the driving part abuts against the movable plug to drive the movable plug to move into the valve body away from the pull-out pipe and thus open the water path;
an inner end of the movable plug passes through the guide valve and out of the pilot hole, and is provided with an inner limiting part radially protruding outwards around the inner end; a sealing plug for sealing the pilot hole is provided between the inner limiting part of the movable plug and the pilot hole; the guide valve cavity is provided with a movable plug opening facing towards the pull-out pipe; an outer end of the movable plug is movable in and out of the movable plug opening; a sealing ring is provided between the outer end of the movable plug and the movable plug opening for sealing the movable plug opening when the outer end of the movable plug moves;
a movable plug elastic member is disposed between the movable plug and a stepped inner wall of the movable plug opening; the movable plug elastic member biases the movable plug such that the outer end of the movable plug extends out of the movable plug opening and the inner end of the movable plug seals the pilot hole.

Further, the driving mechanism comprises a driving part; both the driving part and the movable plug are made of materials that magnetically attract each other; when the driving part approaches the movable plug, the driving part magnetically attracts the movable plug to move so that the movable plug moves to open the water path;
the movable plug is axially movable within the guide valve cavity; a sealing plug for sealing the pilot hole is provided on an outer side of the inner end of the movable plug; a movable plug elastic member is disposed between the outer end of the movable plug and an inner side wall of the guide valve cavity, and the movable plug elastic member biases the movable plug such that the inner end seals the pilot hole.

Further, the driving mechanism comprises a driving sleeve sleeved on the outer side wall of the pull-out pipe; the driving sleeve is driven by the movement of the pull-out pipe to move up and down between a first position and a second position on one side of the non-electrically-driven water outlet assembly; one side of the driving sleeve is provided with the driving part that drives the movable plug to move; after the spray head resets to the original position on the faucet body, the pull-out pipe drives the driving part of the driving sleeve to move away from the movable plug, and thus therefore driving the driving sleeve to be located at the first position; when the spray head is pulled out from the faucet body, the pull-out pipe drives the driving part of the driving sleeve to move to a position that corresponds to the movable plug such that the driving part interacts with the movable plug, and thus therefore driving the driving sleeve to be located at the second position.

Further, a driving sleeve movement cavity is formed on one side of the non-electrically-driven water outlet assembly; the driving sleeve is movable up and down within a confinement defined by the driving sleeve movement cavity; a driving elastic member is arranged in the driving sleeve movement cavity; the driving sleeve and the driving part are biased upwards to be positioned corresponding to the movable plug under an elastic force of the driving elastic member; the pull-out pipe is movable up and down with respect to the driving sleeve; an annular projection limiting part is fixed on the outer side wall of the pull-out pipe; after the spray head resets onto the faucet body, the projection limiting part of the pull-out pipe is limited in the driving sleeve and abuts against the driving sleeve, and so the driving sleeve is driven by the projection limiting part of the pull-out pipe to overcome the elastic force of the driving elastic member and move away from the movable plug such that the driving sleeve is located at the first position; when the spray head is pulled out from the faucet body to an extent that the projection limiting part of the pull-out pipe moves away from the driving sleeve to an extent where the projection limiting part is no longer capable of driving the driving sleeve, the driving sleeve and the driving part thereon are still kept at the second position corresponding to the movable plug under the elastic force of the driving elastic member.

Further, an outer side surface of the projection limiting part is a convex curve that bulges outward in a middle part and tapers off at both upper and lower ends, and the widest part of the projection limiting part is abuttable with an inner wall of the driving sleeve.

Further, the movable plug is mounted in the valve body and movable in and out of the valve body; a movable plug elastic member is disposed between the movable plug and the valve body; the movable plug elastic member biases the movable plug to close the water path, an outer end of the movable plug is biased by the movable plug elastic member to extend out of the valve body facing to the pull-out pipe; the driving mechanism comprises a driving part radially protruding from the outer side wall of the pull-out pipe; the driving part is a projection radially protruding from an outer wall of the driving sleeve, and the projection moves along with the driving sleeve adjacent a side surface of the valve body; when the driving sleeve is moved to the second position, the projection abuts against the outer end of the movable plug so as to drive the inner end of the movable plug to open the water path.

Further, the movable plug is axially movable within the valve body; a movable plug elastic member is disposed between the movable plug and the valve body; the movable plug elastic part biases the movable plug to close the water path; the driving mechanism comprises a driving part; both the driving part and the movable plug are made of materials that magnetically attract each other;
the driving part is a magnet protruding from an outer wall of the driving sleeve; when the driving sleeve is at the second position, the magnet magnetically attracts the outer end of the movable plug to drive the movable plug to move and thus open the water path.

Further, the magnet has a circular side wall, and an axial direction of the magnet corresponds to a movement direction of the movable plug; a shielding cover body is provided in a surrounding area of the magnet.

Further, the non-electrically-driven water outlet assembly is disposed at a valve seat of the faucet body, and being adjacent to one side of the pull-out pipe.

According to the above technical solutions of the present invention, the driving mechanism of the pull-out pipe drives the movable plug to open and close the water path of the spray head in a non-electrical manner, thereby simply and effectively achieving water outflow when the spray head is pulled out and water closure when the spray head resets. The present invention is small and compact in structure, stable in performance, free of power supply, strong in versatility, and low in costs of use.

### BRIEF DESCRIPTION OF THE DRAWINGS

FIG. 1 is a perspective view of Embodiment 1 of the present invention;

FIG. 2 is a sectional view of Embodiment 1 of the present invention;

FIG. 3 is an enlarged view of portion A in FIG. 2, showing a closed state of a water path;

FIG. 4 is an enlarged view of portion A in FIG. 2, showing an opened state of a water path;

FIG. 5 is a perspective view of FIG. 4;

FIG. 6 is a first exploded view of a partial structure of Embodiment 1 of the present invention;

FIG. 7 is a second exploded view of a partial structure of Embodiment 1 of the present invention;

FIG. 8 is a partial sectional view of Embodiment 2 of the present invention, showing a closed state of a water path;

FIG. 9 is a partial sectional view of Embodiment 2 of the present invention, showing an opened state of a water path;

FIG. 10 is a perspective view of FIG. 9;

FIG. 11 is a first exploded view of a partial structure of Embodiment 2 of the present invention;

FIG. 12 is a second exploded view of a partial structure of Embodiment 2 of the present invention;

FIG. 13 is a partial cross-sectional view of Embodiment 3 of the present invention, showing a closed state of a water path;

FIG. 14 is a partial cross-sectional view of Embodiment 3 of the present invention, showing an opened state of a water path;

FIG. 15 is a first exploded view of a partial structure of Embodiment 3 of the present invention;

FIG. 16 is a second exploded view of a partial structure of Embodiment 3 of the present invention;

FIG. 17 is a partial cross-sectional view of Embodiment 4 of the present invention, showing a closed state of a water path;

FIG. 18 is a partial cross-sectional view of Embodiment 4 of the present invention, showing an opened state of a water path;

FIG. 19 is a perspective view of FIG. 18;

FIG. 20 is a first exploded view of a partial structure of Embodiment 4 of the present invention;

FIG. 21 is a second exploded view of a partial structure of Embodiment 4 of the present invention.

Description of the reference numbers: pull-out faucet 100, faucet body 10, valve seat 101, spray head 20, pull-out pipe 30, non-electrically-driven water outlet assembly 40, handle water outlet valve 50, water path W, valve body 1, valve body seat 11, valve body side cover 12, movable plug opening 121, sealing groove 1211, side cover through hole 1211, valve body cavity 13, cavity inlet 131, cavity outlet 132, front-side limiting groove 14, rear-side limiting groove 15, sliding groove 16, water inlet end 2, cold water port 21, hot water port 22, water outlet end 3, movable plug 4, inner end 41, inner limiting part 411, sealing plug 412, outer end 42, outer limiting part 421, movable plug elastic member 43, driving mechanism 5, driving sleeve 51, driving part 511, driving limit part 512, front-side limiting part 513, rear-side limiting part 514, left-side limiting part 515, mounting post 516, shielding cover body 52, lower blocking part 521, inclined upper blocking part 522, upper blocking part 523, pilot valve 6, main valve 61, diaphragm 611, communication hole 6111, left cavity 612, right cavity 613, diaphragm elastic member 614, insertion rod 615, guide valve 62, pilot hole 621, guide valve cavity 622, guide valve hole 623, guide valve cover plate 624, sealing ring 7, driving sleeve movement cavity 8, movement cavity cover plate 81, movement groove 82, driving elastic member 83, and projection limiting part 9.

### DETAILED DESCRIPTION OF THE INVENTION

To make the object, technical solutions, and advantages of the embodiments of the present application clearer, the technical solutions in the embodiments of the present application will be clearly and thoroughly described hereinafter with reference to the drawings in the embodiments of the present application.

### Embodiment 1

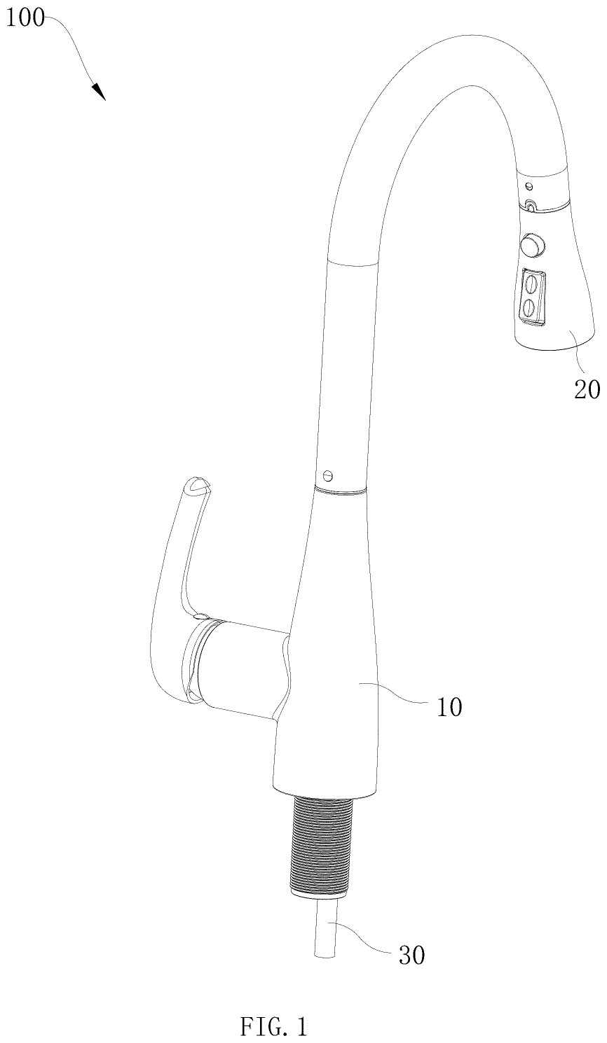

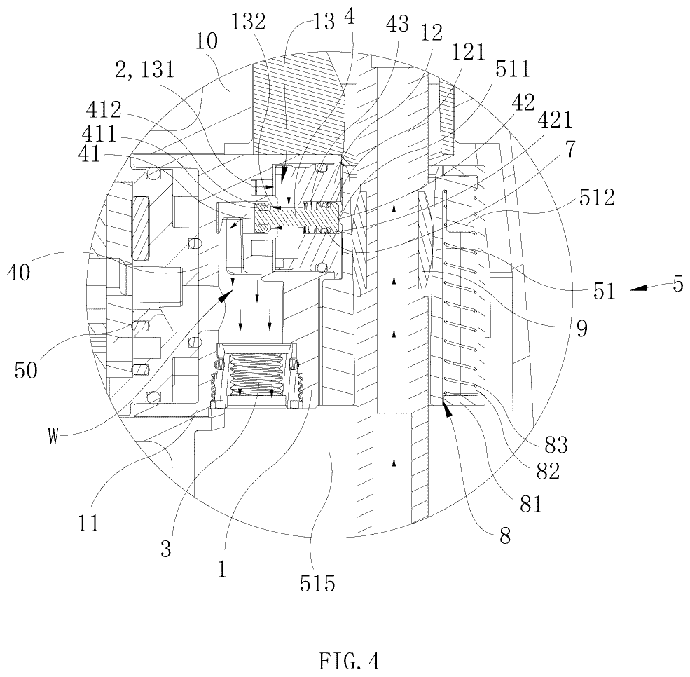

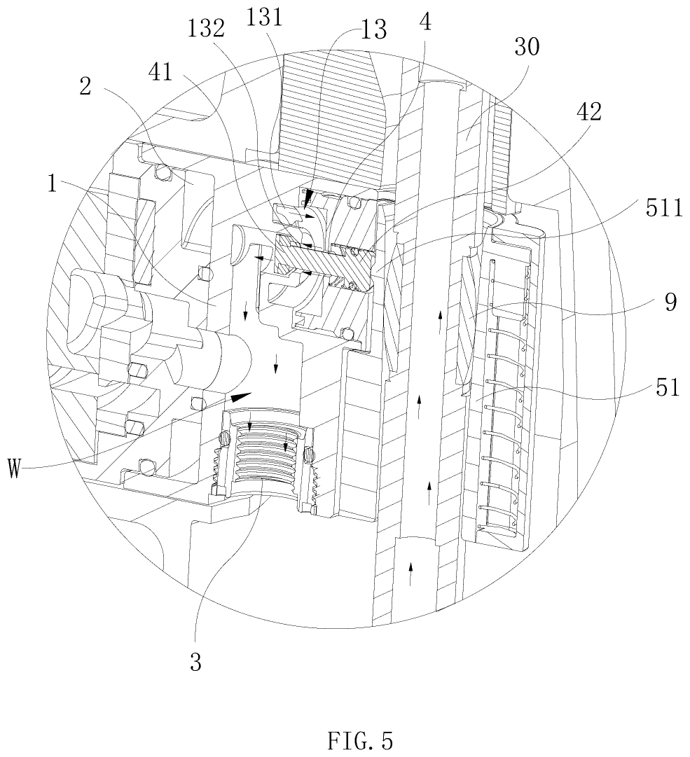

Referring to FIGS. 1 to 7, a pull-out faucet 100 according to the present invention comprises a faucet body 10, a spray head 20, a pull-out pipe 30, and a non-electrically-driven water outlet assembly 40.

The spray head 20 is detachably mounted to one end of the faucet body 10, and the pull-out pipe 30 is movably inserted into the faucet body 10 and is movable axially in the faucet body 10.

One end of the pull-out pipe 30 communicates with the spray head 20, and another end of the pull-out pipe 30 is in communication with (not necessarily in direct connection with) a water outlet end 3 of the non-electrically-driven water outlet assembly 40. The non-electrically-driven water outlet assembly 40 is provided in the faucet body 10 and is located on one side of a portion of the pull-out pipe 30 between said one end and said another end of the pull-out pipe 30. The non-electrically-driven water outlet assembly 40 comprises a valve body 1, a water inlet end 2 provided on the valve body 1 for water inlet, the water outlet end 3 provided on the valve body 1, and a movable plug 4 for opening and closing a water path W between the water inlet end 2 and the water outlet end 3.

A driving mechanism 5 is provided on an outer side wall of the pull-out pipe 30. The spray head 20, when being pulled out from the faucet body 10, drives the pull-out pipe 30 and the driving mechanism 5 to move towards and thus interact with the movable plug 4 in a way that the driving mechanism 5 drives the movable plug 4 to move to open the water path W. After the spray head 20 resets back to the faucet body 10, the driving mechanism 5 is driven to move away from the movable plug 4, and after the driving mechanism 5 moves away from the movable plug 4 so that the movable plug 4 resets to an original position to close the water path W.

The non-electrically-driven water outlet assembly 40 in the present invention refers to a mechanical water outlet valve that does not need to be electrically driven by for example a solenoid valve or an electrically controlled valve.

Therefore, when a user pulls the spray head 20 away from the faucet body 10, the water path W can be directly opened, allowing water to flow from the spray head 20 without the need for an operating handle. A portion of the pull-out pipe 30 passing through a lower portion of the faucet body 10 is configured to be connected to the water outlet end 3 (not particularly illustrated in the figures), and may be provided with a counter weight component (not shown in the figures), such that the spray head 20 can automatically reset to its original position under the counter force of the counter weight component when the user releases the spray head. Alternatively, the spray head 20 can be manually reset to the faucet body 10. Once the reset is complete, the water path W is closed, and the spray head 20 can automatically stop outputting water.

The pull-out faucet 100 according to the present invention is convenient to use, non-electrically driven, highly versatile, does not require electricity, and has low costs of use.

In this embodiment, the water inlet end 2 and the water outlet end 3 are both located on a bottom side the valve body 1 of the non-electrically-driven water outlet assembly 40. The water inlet end 2 may comprises a cold water port 21 and a hot water port 22; the cold water port 21 and the hot water port 22 are located on front and rear sides of the water outlet end 3 respectively. Both the cold water port 21 and the hot water port 22 communicate with a cavity inlet 131 as will be described below, and the cold water port 21 and the hot water port 22 may be externally connected to a cold water inlet pipe and a hot water inlet pipe respectively (not shown in the figures).

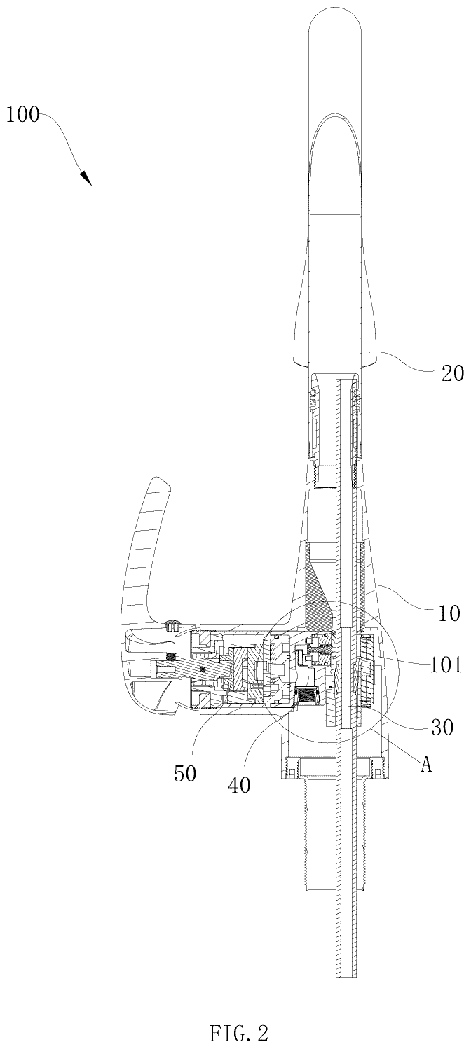

As shown in FIG. 2, the non-electrically-driven water outlet assembly 40, exemplified by a mechanical water outlet valve, may be disposed at a valve seat 101 of the faucet body 10, and the non-electrically-driven water outlet assembly 40 is arranged side by side with a handle water outlet valve 50 also provided in the valve seat 101, thus making full use of an internal space of the faucet body 10 and limiting the overall size of the product. The handle water outlet valve 50 may be an existing conventional handle-operated mixed water valve structure; the cold water port 21 and the hot water port 22 communicate with the cavity inlet 131 after being configured to correspond to the handle water outlet valve 50, thus the cold water port 21 and the hot water port 22 are connected to the water path W so as to provide mixed cold and hot water.

Of course, the water inlet end 2 may be only a single water inlet port, in other words, the water inlet end 2 is not configured to correspond to the handle water outlet valve 50 but just independently supplies water to the water path W.

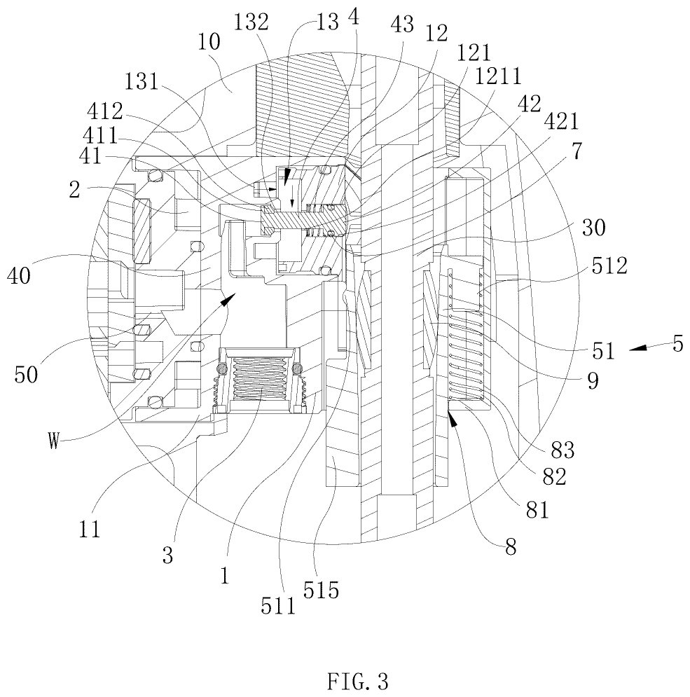

Referring to FIGS. 3 to 5, in this embodiment, the movable plug 4 is mounted in the valve body 1 and movable in the valve body 1; a movable plug elastic member 43 is disposed between the movable plug 4 and the valve body 1. A spring is used as an example of the movable plug elastic member 43 to provide elastic force for the movable plug 4 to reset to an original position. The movable plug elastic member 43 biases an inner end 41 of the movable plug 4 to close the water path W and an outer end 42 of the movable plug 4 to extend out of the valve body 1 facing to the pull-out pipe 30. The driving mechanism 5 comprises a driving part 511 radially protruding from a peripheral side of the pull-out pipe 30, and when the driving mechanism 5 interacts with the movable plug 4, the driving part 511 abuts against the movable plug 4 to drive the movable plug 4 to overcome a biasing force of the movable plug elastic member 43 so as to drive the movable plug 4 to move into the valve body 1 away from the pull-out pipe 30 and thus open the water path W.

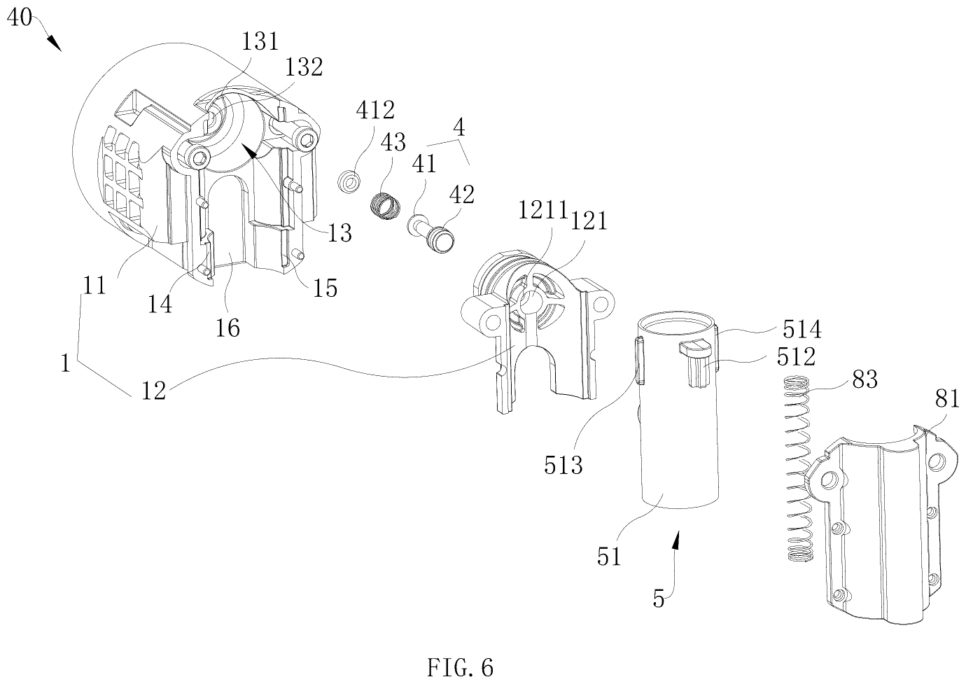

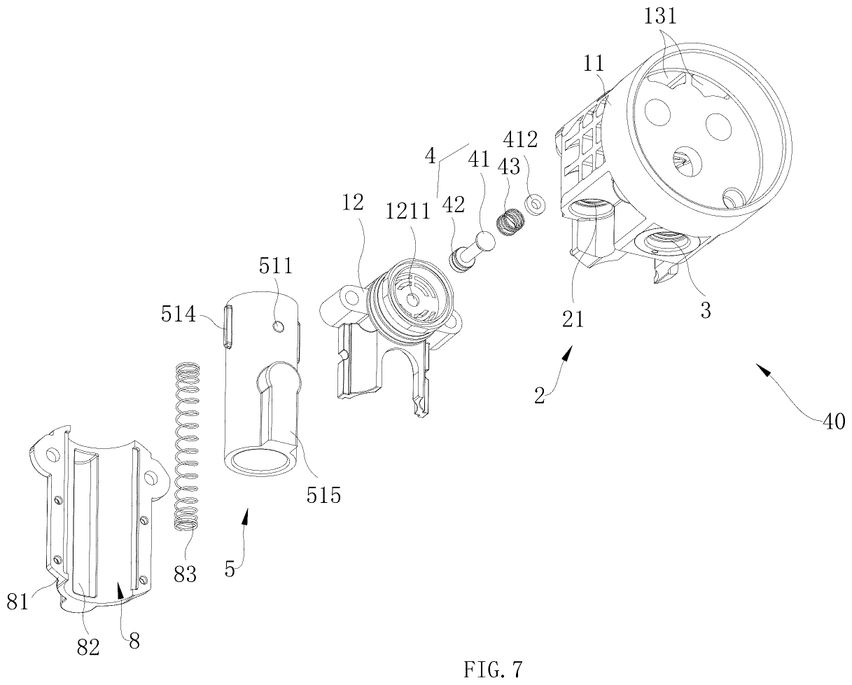

Referring to FIGS. 6 and 7, the valve body 1 of the non-electrically-driven water outlet assembly 40 comprises a valve body seat 11 and a valve body side cover 12 which are side-by-side detachably connected to each other, and both the water inlet end 2 and the water outlet end 3 are located at a bottom side of the valve body seat 11.

A valve body cavity 13 is formed between the valve body side cover 12 and the valve body seat 11; a cavity inlet 131 in communication with the water inlet end 2 is provided on an upper part of the valve body cavity 13, and a cavity outlet 132 in communication with the water outlet end 3 is provided on one side of the cavity inlet 131 of the valve body cavity 13. The valve body side cover 12 is more proximal to the pull-out pipe 30 than the valve body seat 11, and the valve body side cover 12 is provided with a movable plug opening 121 facing to the pull-out pipe 30; a side cover through hole 1211 communicating with the valve body cavity 13 is formed on an inner wall of the movable plug opening 121.

The inner end 41 of the movable plug 4 is used for opening and closing the cavity outlet 132, and the outer end 42 of the movable plug 4 facing to the pull-out pipe 30 is driven by the driving part 511 to drive the inner end 41 to move.

Specifically, in this embodiment, the inner end 41 of the movable plug 4 passes through the valve body cavity 13 and out of the cavity outlet 132, and is provided with an inner limiting part 411 radially protruding outwards around the inner end 41; a sealing plug 412 for sealing the cavity outlet 132 is provided between the inner limiting part 411 of the movable plug 4 and the cavity outlet 132. The outer end 42 of the movable plug 4 is provided with an outer limiting part 421 radially protruding outwards around the outer end 42; the outer limiting part 421 is movable in and out of the movable plug opening 121; a sealing ring 7 is provided sleeving a circumferential periphery of the outer limiting part 421 for sealing the movable plug opening 121 when the outer end 42 of the movable plug 4 moves; the movable plug elastic member 43 is disposed between an inner side surface of the outer limiting part 421 of the movable plug 4 and a stepped inner wall of the movable plug opening 121; the movable plug elastic member 43 biases the movable plug 4 so that the outer end 42 extends out of the movable plug opening 121 and the inner end 41 seals the cavity outlet 132.

Therefore, when the spray head 20 drives the pull-out pipe 30 to move, the pull-out pipe 30 drives the driving mechanism 5 and the protruding driving part 511 to move upward to abut the outer end 42 of the movable plug 4, and so the driving part 511 pushes against the outer end 42 of the movable plug 4, such that the movable plug 4 overcomes the elastic force of the movable plug elastic member 43 and then moves into the valve body cavity 13, accordingly, the inner limiting part 411 at the inner end 41 of the movable plug 4 and the sealing plug 412 are driven to move away from the cavity outlet 132. In this way, the water path W between the water inlet end 2 and the water outlet end 3 is opened, allowing water to flow out of the spray head 20. When the spray head 20 is released and the pull-out pipe 30 resets to its original position, the driving part 511 moves away from the outer end 42 of the movable plug 4, and then the movable plug 4 drives the inner end 41 of the movable plug 4 to reset to its original position under the elastic force of the movable plug elastic member 43, thereby closing the water path W.

As shown in FIGS. 3 to 7, in this embodiment, the driving mechanism 5 comprises a driving sleeve 51 sleeved on the outer side wall of the pull-out pipe 30; the driving sleeve 51 is movable up and down between a first position and a second position on one side of the non-electrically-driven water outlet assembly 40; a left side of an upper portion of the driving sleeve 51 is provided with the driving part 511 that drives the movable plug 4 to move; the driving part 511 is a projection radially protruding from an outer wall of the driving sleeve 51, and the projection moves along with the driving sleeve 51 adjacent a side surface of the valve body 1. When the driving sleeve 51 is moved to the second position, the projection drives the movable plug 4 to move.

After the spray head 20 resets to the original position on the faucet body 10, the pull-out pipe 30 drives the driving part 511 of the driving sleeve 51 to move away from the movable plug 4, and thus the driving sleeve 51 is now located at the first position, and the movable plug 4 also resets to its original position to close the water path W. When the spray head 20 is pulled out from the faucet body 10, the pull-out pipe 30 drives the driving part 511 of the driving sleeve 51 to move to a position that abuts the movable plug 4, and thus the driving sleeve 51 is now located at the second position, and the driving part 511 drives the movable plug 4 to move to open the water path W.

When the spray head 20 and the pull-out pipe 30 are pulled out by a certain distance (which the pull-out pipe 30 can still drives the driving sleeve 51), the driving sleeve 51 is always at the second position, and the spray head 20 always outputs water. However, when the spray head 20 is further pulled out and the pull-out pipe 30 is thus further pulled out (a position which the pull-out pipe 30 may not be able to drive the driving sleeve 51), a driving sleeve movement cavity 8 may be formed on one side of the non-electrically-driven water outlet assembly 40 to ensure that the driving sleeve 51 is always located at the second position even when the pull-out pipe 30 is further pulled out to the position which the pull-out pipe 30 is no longer able to drive the driving sleeve 51; the driving sleeve 51 is movable up and down within a confinement defined by the driving sleeve movement cavity 8.

Specifically, the driving sleeve movement cavity 8 is a recess formed on a movement cavity cover plate 81 which is fixed to a right side of the valve body seat 11 and the valve body side cover 12 of the valve body 1; a movement groove 82 is further recessed on a right side of the driving sleeve movement cavity 8; a driving elastic member 83 is arranged in the movement groove 82, movement of the driving sleeve 51 is limited by the driving sleeve movement cavity 8; a driving limit part 512 is protruded from a side wall of the driving sleeve 51 facing to the movement groove 82, and the driving limit part 512 is connected to one end of the driving elastic member 83. In this embodiment, the driving elastic member 83 is a spring, the driving limit part 512 is inserted into an upper end of the spring, a lower end of the spring is fixed to an inner bottom side of the movement groove 82. Accordingly, the driving sleeve 51 and the driving part 511 are biased upwards to abut the movable plug 4 under the elastic force of the driving elastic member 83.

A front-side limiting part 513 and a rear-side limiting part 514 are further protruded from a front side and a rear side of the driving sleeve 51 respectively; a left-side limiting part 515 positioned below the driving part 511 is further protruded from a left side of the driving sleeve 51. The front-side limiting part 513 and the rear-side limiting part 514 are slidably fitted into a front-side limiting groove 14 and a rear-side limiting groove 15 formed between the movement cavity cover plate 81 and the valve body 1 after the movement cavity cover plate 81 is connected with the valve body seat 11 and the valve body side cover 12 of the valve body 1, and the left-side limiting part 515 is slidably fitted in a sliding groove 16 provided on the right side of the valve body seat 11; accordingly, the front-side limiting part 513, the rear-side limiting part 514, and the left-side limiting part 515 are cooperatively provided in cooperation with the driving limit part 512 such that a range of vertical movement of the driving sleeve 51 is limited within the driving sleeve movement cavity 8, and the movement of the driving sleeve 51 is stably guided by the driving sleeve movement cavity 8.

The pull-out pipe 30 is movable up and down with respect to the driving sleeve 51; an annular projection limiting part 9 is fixed on the outer side wall of the pull-out pipe 30, an outer side surface of the projection limiting part 9 is a convex curve that bulges outward in a middle part and tapers off at both upper and lower ends, and the widest part of the projection limiting part 9 is abuttable with an inner wall of the driving sleeve 51. After the spray head 20 resets onto the faucet body 10, the projection limiting part 9 of the pull-out pipe 30 is limited in the driving sleeve 51 and abuts against the driving sleeve 51, and so the driving sleeve 51 is driven by the projection limiting part 9 of the pull-out pipe 30 through frictional force to overcome the elastic force of the driving elastic member 83 (i.e. compress the driving elastic member 83) and move away from the movable plug 4 such that the driving sleeve is located at the first position. When the spray head 20 is pulled out from the faucet body 10 to an extent that the projection limiting part 9 of the pull-out pipe 30 moves away from the driving sleeve 51 in that the projection limiting part 9 can no longer drive the driving sleeve 51, the driving sleeve 51 and the driving part 511 thereon are still kept abutting against the movable plug 4 at the second position under the elastic force of the driving elastic member 83.

Moreover, when the spray head 20 is pulled out from the faucet body 10, there is a situation where an upward movement distance of the pull-out pipe 30 is greater than an upward movement distance of the driving sleeve 51 because the range of vertical movement of the driving sleeve 51 is limited by the driving sleeve movement cavity 8, thereby preventing the driving sleeve 51 from further moving upwardly together with the pull-out pipe 30; since the widest part of the projection limiting part 9 is abuttable with the driving sleeve 51, and a pulling force applied to the pull-out pipe 30 and the projection limiting part 9 should be greater than the maximum static friction force between the projection limiting part 9 and the driving sleeve 51 (such that the pull-out pipe 30 can be pulled out), the projection limiting part 9 will be separated from the driving sleeve 51 as the pull-out pipe 30 continues to move upwards. Without the abutting force of the projection limiting part 9, the driving sleeve 51 has a tendency to descend due to gravity, but such gravitational force can be overcome by the support of the driving elastic member 83; accordingly, the driving part 511 of the driving sleeve 51 is always kept at the second position, thus guaranteeing a continuous water outflow from the spray head 20.

In another embodiment, to ensure that the driving sleeve 51 remains at the second position when the spray head 20 is further pulled out, the driving sleeve movement cavity 8 as described in the first embodiment can be provided, and the driving sleeve 51 as described in the first embodiment is as well configured to be movable up and down within the confinement defined by the driving sleeve movement cavity 8. In addition to the first embodiment, said another embodiment of the present invention provides a driving sleeve extension part (not shown in the figures) integrally provided at the upper portion of the driving sleeve 51 extending beyond an upper end of the driving sleeve movement cavity 8; the driving sleeve extension part, having the same inner diameter as the driving sleeve 51, sleeves on the outer side surface of the pull-out pipe 30 and extends axially along the pull-out pipe 30 in a direction away from the spray head 20. In said another embodiment, the driving elastic member 83 can be omitted. When the projection limiting part 9 continues to move further upwards along with the pull-out pipe 30 to an extent that the projection limiting part 9 is separated from the driving sleeve 51, the projection limiting part 9 can still further move continuously in the driving sleeve extension part, and this can drive the driving sleeve 51 to overcome its own weight (i.e. the gravitational force of the driving sleeve 51) and always remain limited in a position in the driving sleeve movement cavity 8 corresponding to the second position, thereby ensuring continuous water outflow from the spray head 20. Moreover, said another embodiment has the advantage that water outflow can be stopped immediately when the spray head 20 starts to reset. Specifically, when the spray head 20 drives the pull-out pipe 30 to reset, the projection limiting part 9 of the pull-out pipe 30 can immediately drive the driving sleeve extension part and thus the driving sleeve 51 to move downwards so that the driving part 511 moves away from the movable plug 4 immediately, and as a result, water outflow can be stopped immediately when the spray head starts to reset, and this may avoid the problem of water splashing in the resetting process of the spray head 20.

In the first embodiment of the present invention, the driving part 511 in form of a projection is used as an exemplary embodiment in the driving sleeve 51 of the driving mechanism 5. In this first embodiment, the driving sleeve 51 can always be maintained at the second position to ensure that the movable plug 4 always opens the water path W. Of course, the driving sleeve 51 may also be omitted, and the driving part 511 in form of the projection is directly provided on the outer side wall of the pull-out pipe 30 in form of an elongated strip (not shown in the figures) extending axially along the pull-out pipe 30, such that when the spray head 20 is pulled out, the elongated strip can always abut the movable plug 4 to keep the driving the inner end 41 of the movable plug 4 opening the water path W.

### Embodiment 2

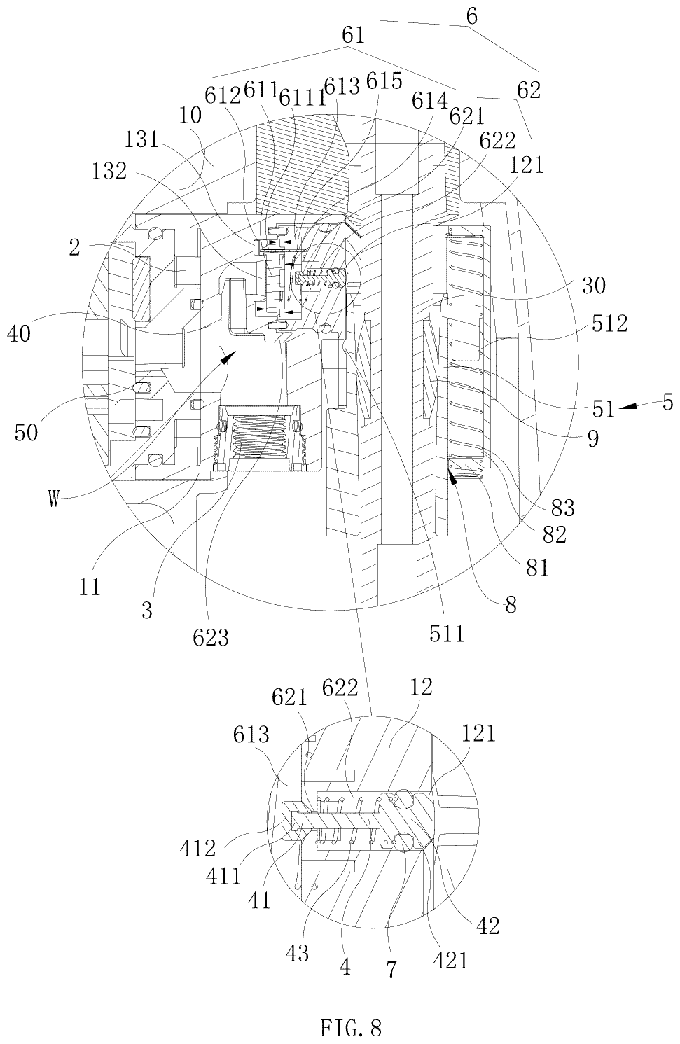

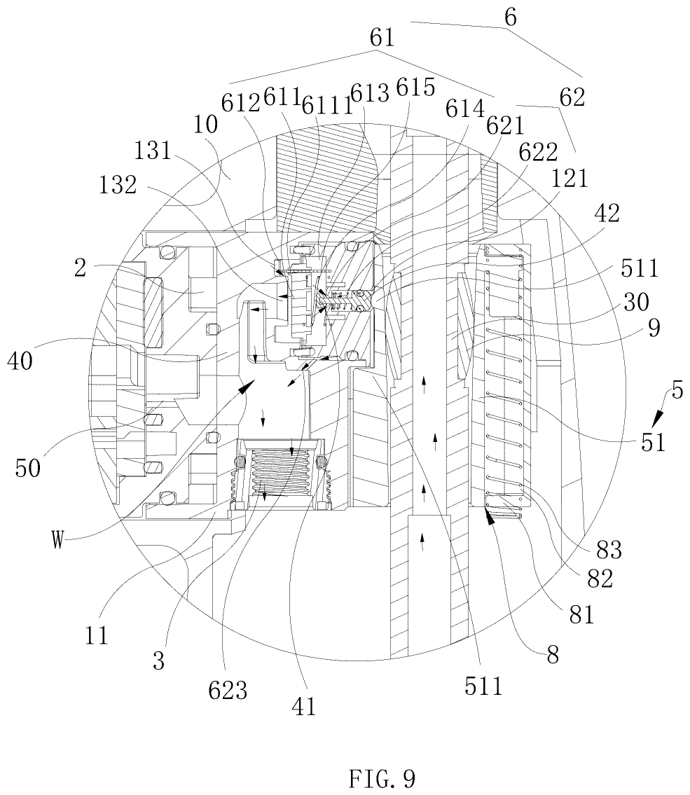

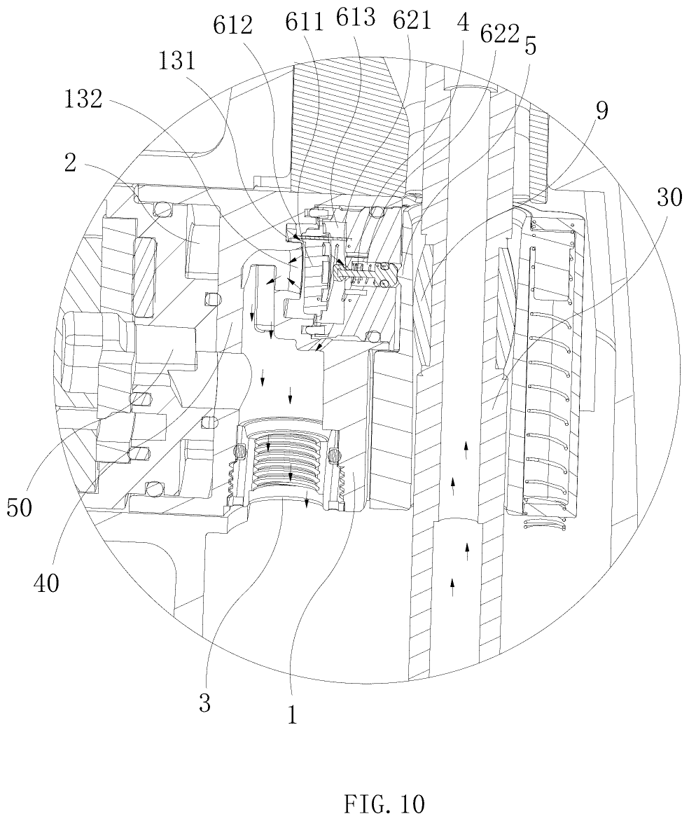

As shown in FIGS. 8 to 12, the basic principle of this embodiment is the same as that of Embodiment 1, and the main differences in this embodiment are related to the specific structures of the non-electrically-driven water outlet assembly 40.

With reference to FIGS. 8 to 10, in this embodiment, a pilot valve 6 is provided in the water path W of the valve body 1 of the non-electrically-driven water outlet assembly 40. A main valve 61 of the pilot valve 6 has a left cavity 612 and a right cavity 613 separated by a diaphragm 611. The left cavity 612 is provided with a cavity outlet 132 that is capable of allowing communication between the water inlet end 2 and the water outlet end 3, and the right cavity 613 communicates with a guide valve 62. A diaphragm elastic member 614 is provided in the right cavity 613, which applies an elastic force against the diaphragm 611 to bias the diaphragm 611 to removably block the cavity outlet 132; the diaphragm elastic member 614 is exemplified as a spring. A communication hole 6111 communicating the left cavity 612 and the right cavity 613 is provided on the diaphragm 611 at a position on the diaphragm 611 corresponding to a point outside a periphery of the cavity outlet 132. The movable plug 4 is movable to open and close a pilot hole 621 of the guide valve 62 to allow the guide valve 62 to allow and disallow communication between the right cavity 613 of the main valve 61 and the water outlet end 3, thereby controlling the diaphragm 611 to open the cavity outlet 132 to open the water path W. A diameter of the cavity outlet 132 is greater than that a diameter of the pilot hole 621, and the diameter of the pilot hole 621 is greater than a diameter of the communication hole 6111.

By providing the pilot valve 6, the pilot hole 621 is elastically closed by the movable plug 4 in an initial state, and water entering into the left cavity 612 from the water inlet end 2 also enters the right cavity 613 from the left cavity 612, such that water pressure in the left cavity 612 is kept balanced with water pressure in the right cavity 613, and the diaphragm 611 biased by the diaphragm elastic member 614 stably blocks the cavity outlet 132 in the left cavity 612. When the spray head 20 is pulled out and the pull-out pipe 30 is driven to move upwards, upward movement of the pull-out pipe 30 drives the driving mechanism 5 that in turns drives the movable plug 4 to move and open the pilot hole 621, such that the guide valve 62 allows communication between the right cavity 613 and the water outlet end 3, in other words, water in the right cavity 613 flows out from the water outlet end 3. Since the diameter of the pilot hole 621 is greater than the diameter of the communication hole 6111, the water pressure in the right cavity 613 drops and is smaller than the water pressure in the left cavity 612. Therefore, water in the left cavity 612 presses the diaphragm 611 to move to compress the diaphragm elastic member 614, and so the diaphragm 611 opens the cavity outlet 132, thereby connecting the water path W between the water inlet end 2 and the water outlet end 3.

After the spray head 20 resets to its original position, the movable plug 4 resets to block the pilot hole 621 again. The water pressure in the right cavity 613 increases again, and this increased water pressure in the right cavity 613, together with the resetting force of the diaphragm elastic member 614, drives the diaphragm 611 to block the cavity outlet 132 of the left cavity 612 again, thereby closing the water path W.

Because the diameter of the pilot hole 621 is much smaller than the diameter of the cavity outlet 132, opening and closing of the pilot hole 621 can control opening and closing of the water path W, as such, the driving part 511 can overcome the water pressure to open the water path W with only a small driving force. This ensures the reliability of the product and makes operations more effortless.

In this embodiment, the main valve 61 and the guide valve 62 of the pilot valve 6 are arranged side by side and are coaxially provided on one side of the pull-out pipe 30 which is movable up and down, and the guide valve 62 is disposed more proximal to the pull-out pipe 30 than the main valve. The pilot hole 621 of the guide valve 62 is located between a guide valve cavity 622 of the guide valve 62 and the right cavity 613, and a guide valve hole 623 is formed between the guide valve cavity 622 and the water outlet end 3. The movable plug 4 is movable left and right in the guide valve cavity 622.

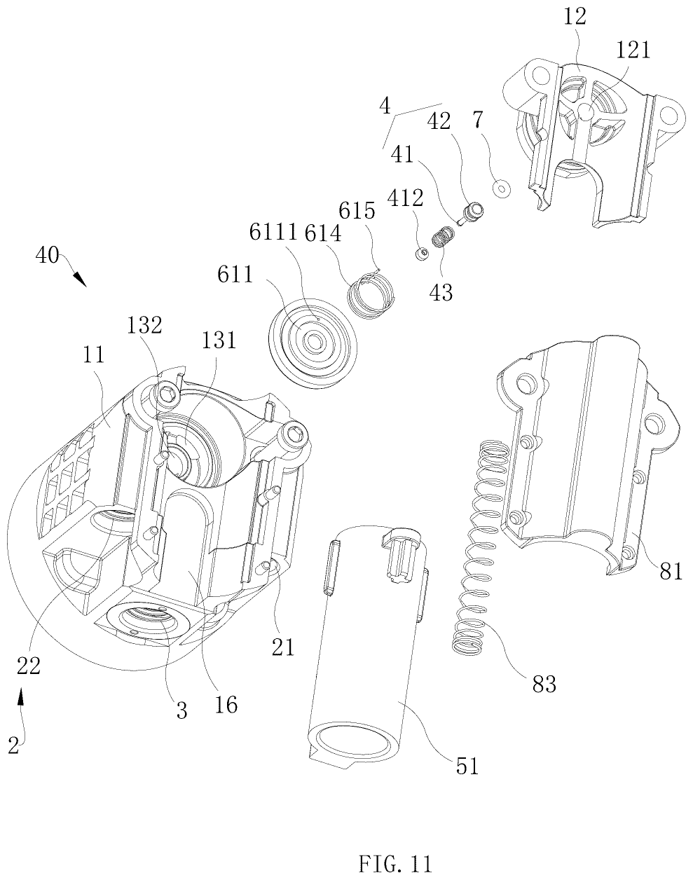

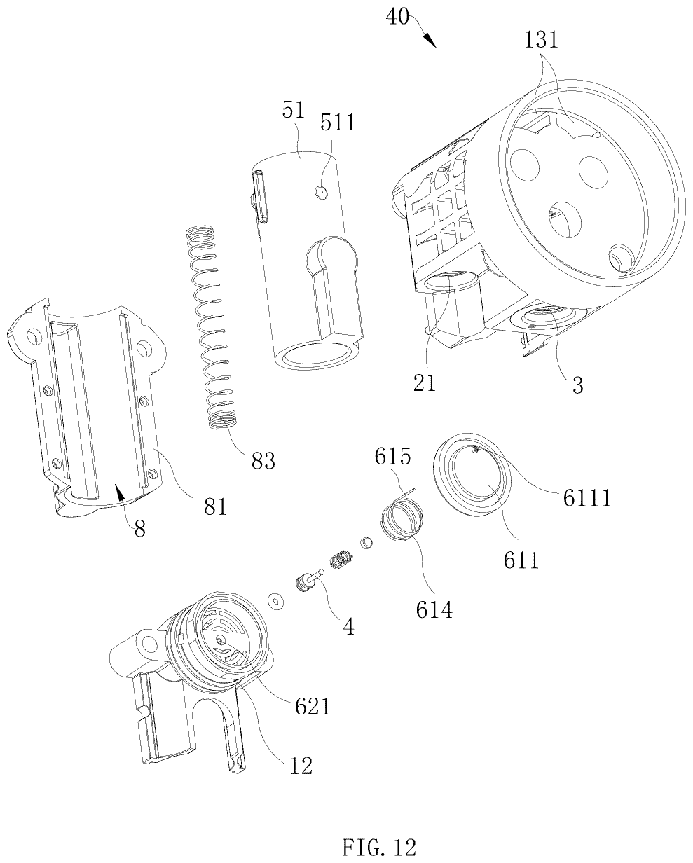

Referring to FIGS. 11 and 12, the valve body 1 of the non-electrically-driven water outlet assembly 40 comprises a valve body seat 11 and a valve body side cover 12 which are side-by-side detachably connected to each other. The left cavity 612 and the right cavity 613 of the main valve 61 are formed between the valve body side cover 12 and the valve body seat 11; the periphery of the diaphragm 611 is fixed between the valve body side cover 12 and the valve body seat 11, the upper portion of the left cavity 612 is provided with a cavity inlet 131 in communication with the water inlet end 2, and a middle part of the left cavity 612 is provided with the cavity outlet 132 in communication with the water outlet end 3. The valve body side cover 12 is more proximal to the pull-out pipe 30 than the valve body seat 11 and is provided with the guide valve cavity 622; the pilot hole 621 in communication with the right cavity 613 is formed on an interior of the guide valve cavity 622, and a movable plug opening 121 facing to the pull-out pipe 30 is formed on an outer side of the guide valve cavity 622.

The movable plug 4 is axially movable in and out of the guide valve cavity 622. The inner end 41 of the movable plug 4 passes through the guide valve 62 and out of the pilot hole 621, and is provided with an inner limiting part 411 radially protruding outwards around the inner end 41, and a sealing plug 412 for sealing the pilot hole 621 is provided between the inner limiting part 411 of the movable plug 4 and the pilot hole 621. The outer end 42 of the movable plug 4 is provided with an outer limiting part 421 radially protruding outwards around the outer end 42; the outer limiting part 421 is movable in and out of the movable plug opening 121; a sealing ring 7 is provided sleeving a circumferential periphery of the outer limiting part 421 for sealing the movable plug opening 121 when the outer end 42 of the movable plug 4 moves. A movable plug elastic member 43 is disposed between the outer limiting part 421 of the movable plug 4 and a stepped inner wall of the movable plug opening 121; the movable plug elastic member 43 biases the movable plug 4 to such that the outer end 42 of the movable plug 4 extends out of the movable plug opening 121 and the inner end 41 of the movable plug 4 seals the pilot hole 621.

Further, an insertion rod 615 extending from the right cavity 613 to the left cavity 612 is provided within the communication hole 6111 of the diaphragm 611. Since the diaphragm 611 is movable relative to the insertion rod 615, the insertion rod 615 has a cleaning effect to prevent the communication hole 6111 from being blocked.

### Embodiment 3

This embodiment is the same as the basic principle and basic structure of Embodiment 2, and the main differences are the structures of the pilot valve 6 in the non-electrically-driven water outlet assembly 40.

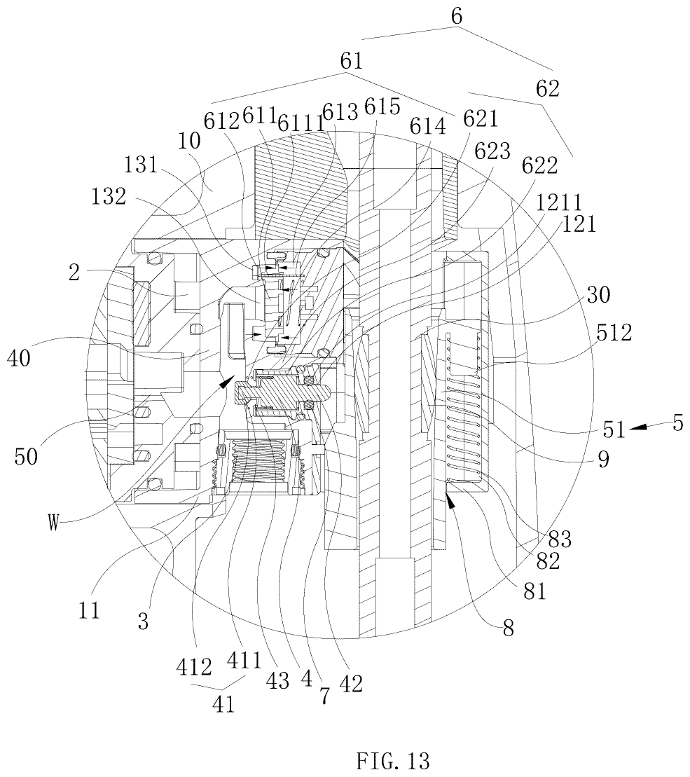

As shown in FIGS. 13 to 16, in this embodiment, the main valve 61 and the guide valve 62 of the pilot valve 6 are arranged in parallel in an up-down direction corresponding to a moving direction of the pull-out pipe 30 in the pull-out faucet; the pilot valve 6 is positioned on one side of the pull-out pipe 30; accordingly, a width of the non-electrically-driven water outlet assembly 40 can be reduced, and the full utilization of the space within the faucet body 10 is facilitated.

The pilot hole 621 of the guide valve 62 is located between the guide valve cavity 622 and the water outlet end 3, and the guide valve hole 623 is formed between the guide valve cavity 622 and the right cavity 613 of the main valve 61. The movable plug 4 is axially movable in and out of the guide valve cavity 622.

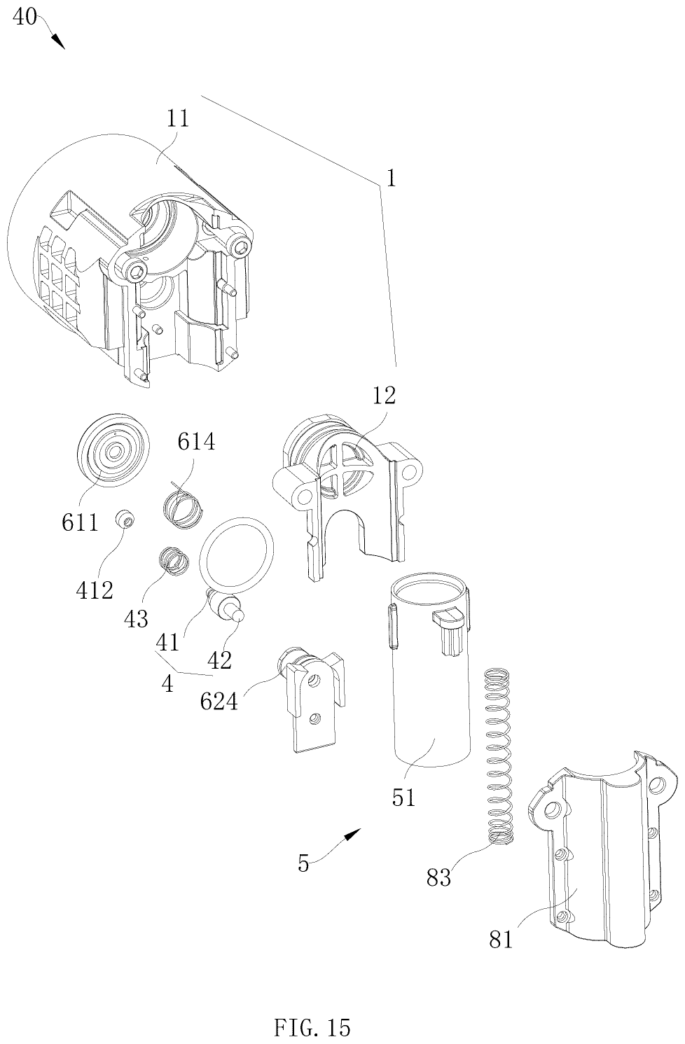

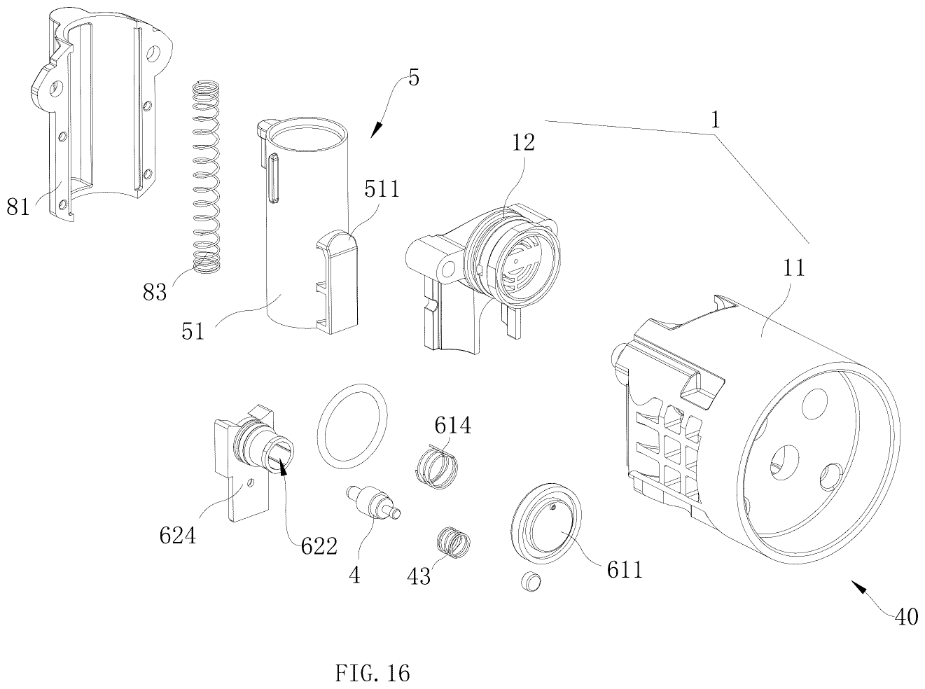

Referring to FIGS. 15 and 16, the valve body 1 of the non-electrically-driven water outlet assembly 40 comprises a valve body seat 11, a valve body side cover 12, and a guide valve cover plate 624, where the valve body side cover 12 and the guide valve cover plate 624 are detachably connected side-by-side with the valve body seat 11.

A left cavity 612 and the right cavity 613 of the main valve 61 are formed between the valve body side cover 12 and the valve body seat 11; a periphery of the diaphragm 611 is fixed between the valve body side cover 12 and the valve body seat 11; an upper portion of the left cavity 612 is provided with the cavity inlet 131 in communication with the water inlet end 2, and a middle part of the left cavity 612 is provided with the cavity outlet 132 in communication with the water outlet end 3.

The guide valve cover plate 624 is located below the valve body side cover 12 and adjacent to the pull-out pipe 30; the guide valve cavity 622 is formed between the guide valve cover plate 624 and the valve body seat 11; the pilot hole 621 in communication with the water outlet end 3 is formed on an interior of the guide valve cavity 622; and a movable plug opening 121 facing to the pull-out pipe 30 is formed on an outer side of the guide valve cavity 622.

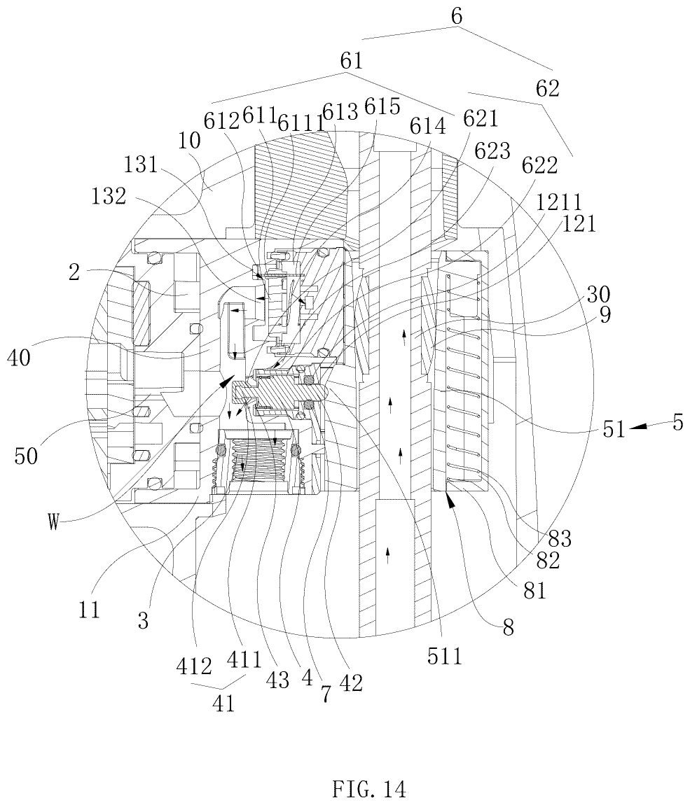

Referring to FIGS. 13 and 14, the movable plug 4 is axially movable in and out of the guide valve cavity 622. The inner end 41 of the movable plug 4 passes through the guide valve 62 and out of the pilot hole 621, and is provided with an inner limiting part 411 radially protruding outwards around the inner end 41; a sealing plug 412 for sealing the pilot hole 621 is provided between the inner limiting part 411 of the movable plug 4 and the pilot hole 621; the outer end 42 of the movable plug 4 is movable in and out of the movable plug opening 121; an annular sealing groove 1211 is formed on an inner side of the movable plug opening 121, and a sealing ring 7 is provided in the sealing groove 1211 for sealing the movable plug opening 121 when the outer end 42 of the movable plug 4 moves; a movable plug elastic member 43 is disposed between the movable plug 4 and the guide valve cavity 622, and the movable plug elastic member 43 biases the movable plug 4 such that the outer end 42 extends out of the movable plug opening 121 and the inner end 41 seals the pilot hole 621.

It should be noticed that the sealing ring 7 in this embodiment is also mounted in a different way compared with Embodiment 2. Given that the sealing ring 7 can seal the movable plug opening 121 to prevent water leakage when the outer end 42 of the main movable plug 4 moves, mounting of the sealing ring 7 shall not be specifically limited to this embodiment, but can also be in other ways described in other embodiments.

Sealing rings 7 may also be provided on the valve body side cover 12 and the guide valve cover plate 624 to seal against the valve body seat 11 when the valve body side cover 12 and the guide valve cover plate 624 are connected to the valve body seat 11.

In this embodiment, the outer end 42 of the movable plug 4 is located at a lower position compared with the previous two embodiments, and so the corresponding driving part 511 of the driving sleeve 51 in this embodiment is also located correspondingly at a lower position compared with the previous two embodiments.

### Embodiment 4

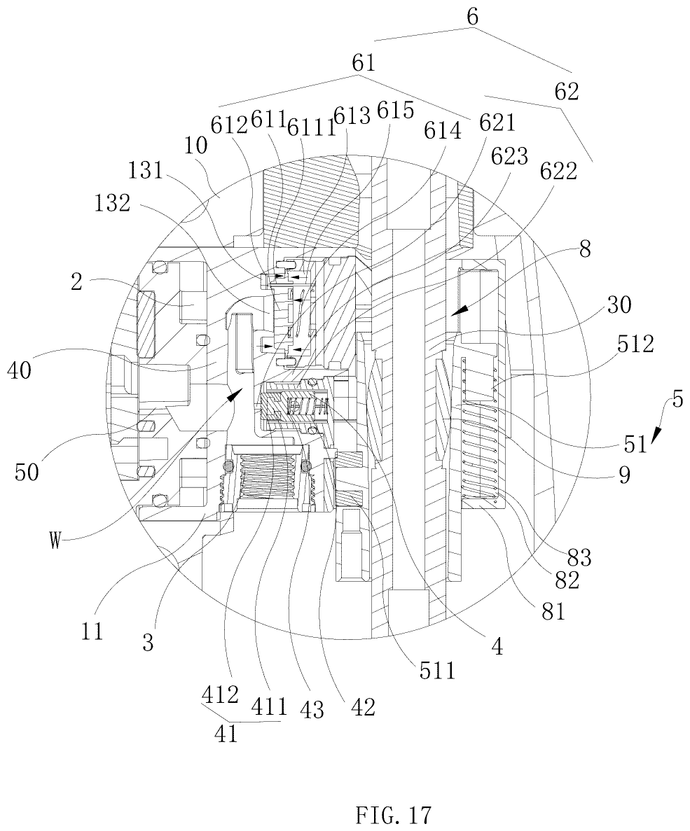

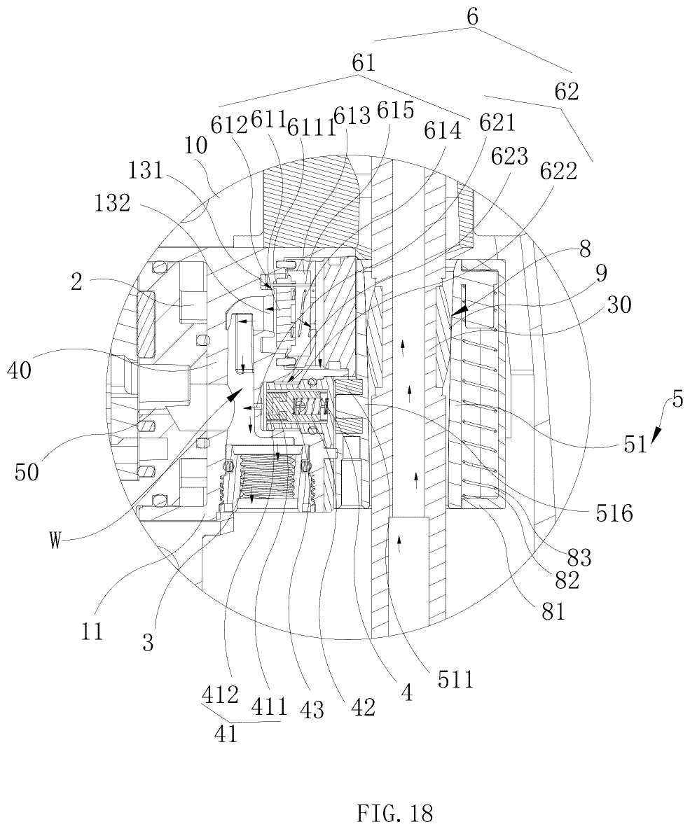

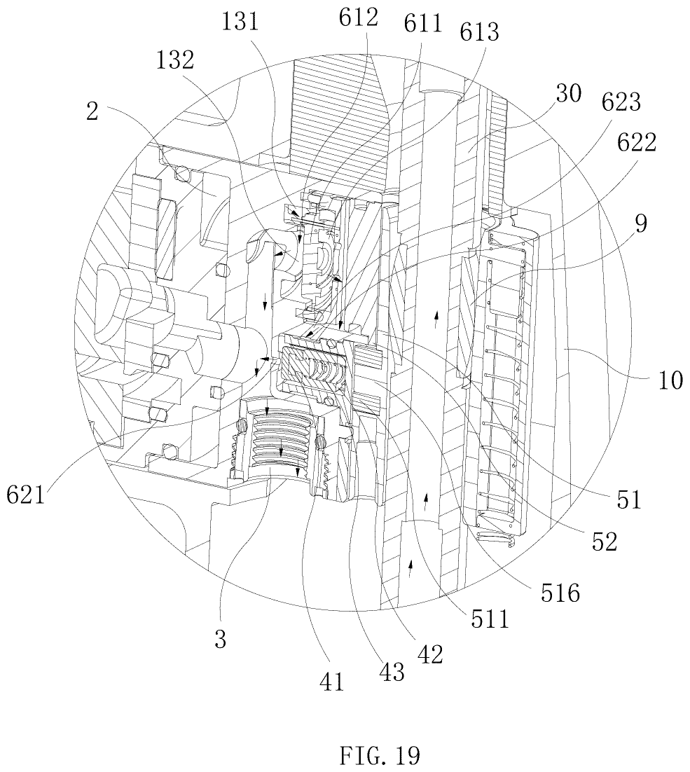

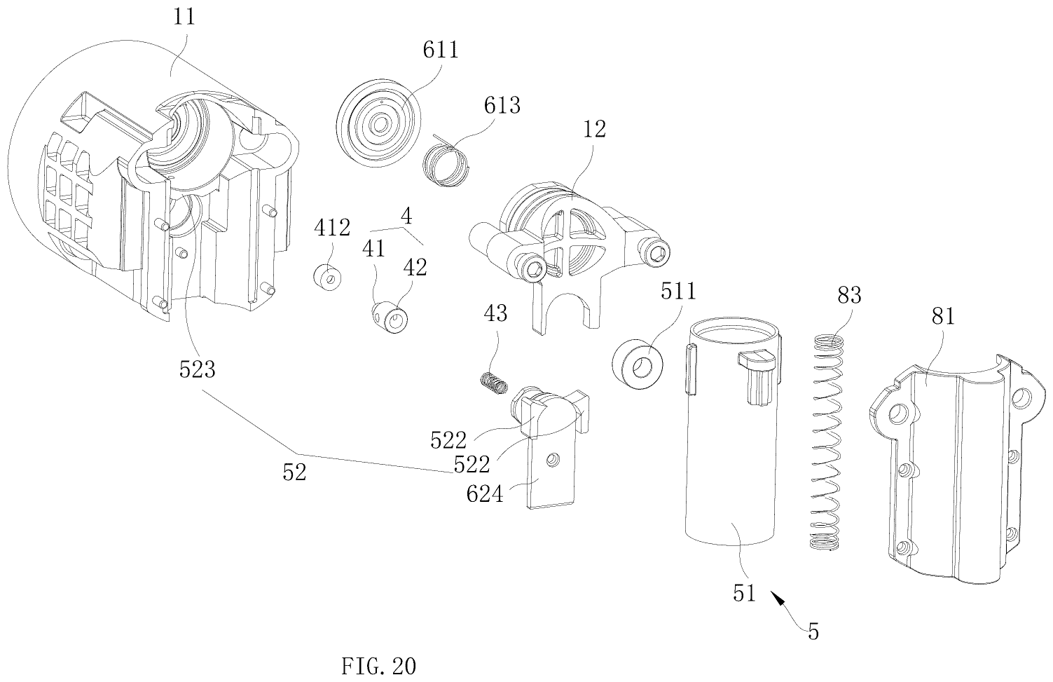

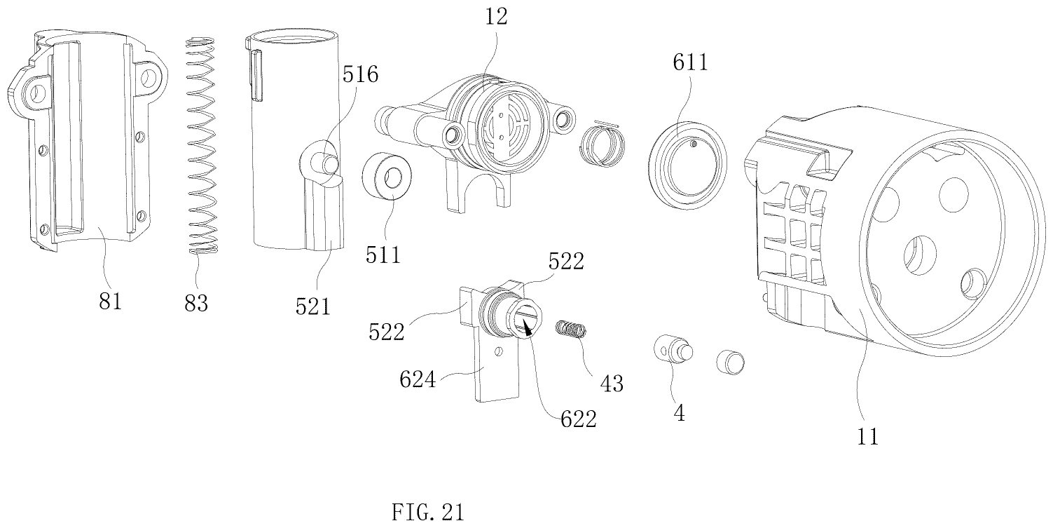

As shown in FIGS. 17 to 21, this embodiment is the same as the basic principle and the basic structure of Embodiment 3, and the main difference are the structures of the non-electrically-driven water outlet assembly 40, the movable plug 4, and the driving part 511.

In this embodiment, the movable plug 4 is axially movable within the valve body 1; a movable plug elastic member 43 is disposed between the movable plug 4 and the valve body 1; the movable plug elastic part 43 biases the movable plug 4 to close the water path W; the driving mechanism 5 comprises a driving part 511; both the driving part 511 and the movable plug 4 are made of materials that magnetically attract each other; when the driving part 511 approaches the movable plug 4, the driving part 511 magnetically attracts the movable plug 4 to move so that the movable plug overcomes an elastic force of the movable plug elastic part 43 and moves to open the water path W. In this embodiment, the movable plug 4 is made of a magnetic material, and the driving part 511 is a magnet protruding from an outer wall of the driving sleeve 51. When the driving sleeve 51 is at the second position, the magnet drives the movable plug 4 to move.

Specifically, the movable plug 4 is axially movable in the valve cavity 622; a sealing plug 412 for sealing the pilot hole 621 is provided on an outer side of the inner end 41 of the movable plug 4, and the sealing plug 412 wraps the inner end 41 of the movable plug 4; the outer end 42 of the movable plug 4 is recessed towards the inner side 41, and a movable plug elastic member 43 is disposed between a bottom side of the recessed outer end 42 and an inner side wall of the guide valve cavity 622, and the movable plug elastic member 43 biases the movable plug 4 such that the inner end 41 seals the pilot hole 621.

In this embodiment, the magnet is an annular magnet with a circular side wall. The magnet is mounted on a mounting post 516 protruding from a side wall of the driving sleeve 51. The movable plug 4 is cylindrical; an axial direction of the magnet corresponds to a movement direction of the movable plug 4. As shown in the figures, the movable plug 4 is located on a left side of the magnet along the axial direction of the magnet; a shielding cover body 52 is provided in a surrounding area of the magnet. As shown in the figures, the surrounding area of the magnet which the shield cover body 52 is provided comprises areas on a top side, on a bottom side, on a left, and on a right side of the magnet.

The shielding cover body 52 comprises a lower blocking part 521 provided on an outer wall of the driving sleeve 51 below the magnet, two symmetrically arranged inclined upper blocking parts 522 provided on the guide valve cover plate 624, and an upper blocking part 523 provided on the valve body seat 11 at a position between the two inclined upper blocking parts 522 on the guide valve cover plate 624. Surrounding the magnet by the shielding cover body 52 enables focused magnetic force such that the effect of a large driving force can also be achieved by a small magnet, and so the production costs of the product are effectively reduced.

In this embodiment, magnetic attraction is used in lieu of the projection to drive the movable plug 4 to move, and in this way, the water path W is still opened and closed via a non-electrical structure. It should be noted that how the movable plug is driven by the driving part 511 should not be limited to the specific embodiment described herein.

A water outlet assembly in the prior art is usually electrically driven. An electrically-driven water outlet assembly, such as a solenoid valve, relies on an external power supply to control the opening or closing of the movable plug and has the defects of requiring continuous power supply, and so its range of applications is limited. In the present invention, a non-electrically-driven manner is adopted, that is, the movable plug can be opened or closed without requiring an external power supply for the water outlet assembly.

In conclusion, in the present invention, the driving mechanism 5 of the pull-out pipe 30 drives the movable plug 4 to open and close the water path W of the spray head 20 in a non-electrical manner, thereby simply and effectively achieving water outflow when the spray head 20 is pulled out and water closure when the spray head 20 resets. The present invention is small and compact in structure, stable in performance, free of power supply, strong in versatility, and low in costs of use.

What is claimed is:

1. A pull-out faucet, comprising:
a faucet body, a spray head, a pull-out pipe, and a non-electrically-driven water outlet assembly;
the spray head is detachably mounted to one end of the faucet body;
the pull-out pipe is movably inserted into the faucet body and is movable axially in the faucet body; one end of the pull-out pipe communicates with the spray head, and another end of the pull-out pipe is in communication with a water outlet end of the non-electrically-driven water outlet assembly;
the non-electrically-driven water outlet assembly is provided in the faucet body; the non-electrically-driven water outlet assembly comprises a valve body, a water inlet end provided on the valve body and through which entry of water is achieved, the water outlet end provided on the valve body, and a movable plug capable of opening and closing a water path between the water inlet end and the water outlet end;
a driving mechanism is provided on an outer side wall of the pull-out pipe; the spray head, when being pulled out from the faucet body, drives the pull-out pipe and the driving mechanism to move to a position corresponding to the movable plug and thus interact with the movable plug in a way that the driving mechanism drives the movable plug to move to open the water path; the spray head, when being reset onto the faucet body, drives the pull-out pipe and the driving mechanism to move away from the movable plug so that the movable plug is driven to move oppositely to close the water path.

2. The pull-out faucet of claim 1, wherein the movable plug is mounted in the valve body and movable in and out of the valve body; a movable plug elastic member is disposed between the movable plug and the valve body; the movable plug elastic member biases the movable plug to close the water path, an outer end of the movable plug is biased by the movable plug elastic member to extend out of the valve body facing to the pull-out pipe; the driving mechanism comprises a driving part radially protruding from the outer side wall of the pull-out pipe; when the driving mechanism interacts with the movable plug, the driving part abuts against the movable plug to drive the movable plug to overcome a biasing force of the movable plug elastic member so as to drive the movable plug to move into the valve body away from the pull-out pipe and thus open the water path.

3. The pull-out faucet of claim 1, wherein the movable plug is axially movable within the valve body; a movable plug elastic member is disposed between the movable plug and the valve body; the movable plug elastic part biases the movable plug to close the water path; the driving mechanism comprises a driving part; both the driving part and the movable plug are made of materials that magnetically attract each other; when the driving part approaches the movable plug, the driving part magnetically attracts the movable plug to move so that the movable plug overcomes an elastic force of the movable plug elastic part and moves to open the water path.

4. The pull-out faucet of claim 1, wherein the valve body of the non-electrically-driven water outlet assembly comprises a valve body seat and a valve body side cover which are side-by-side detachably connected to each other; a valve body cavity is formed between the valve body side cover and the valve body seat; a cavity inlet in communication with the water inlet end is provided on the valve body cavity, and a cavity outlet in communication with the water outlet end is provided on one side of the cavity inlet of the valve body cavity; the movable plug is axially movable in and out of the valve body cavity;
an inner end of the movable plug is capable of opening and closing the cavity outlet, and an outer end of the movable plug facing to the pull-out pipe is capable of being driven by the driving part to drive the inner end to move.

5. The pull-out faucet of claim 1, wherein a pilot valve is provided in the water path of the valve body; the pilot valve comprises a main valve and a guide valve; the main valve has a left cavity and a right cavity separated by a diaphragm; the left cavity is provided with a cavity outlet that is capable of allowing communication between the water inlet end and the water outlet end, and the right cavity communicates with the guide valve; a diaphragm elastic member is provided in the right cavity, the diaphragm elastic member applies an elastic force against the diaphragm to bias the diaphragm to removably block the cavity outlet; a communication hole communicating the left cavity and the right cavity is provided on the diaphragm at a position on the diaphragm corresponding to a point outside a periphery of the cavity outlet; the movable plug is movable to open and close a pilot hole of the guide valve to allow the guide valve to allow and disallow communication between the right cavity of the main valve and the water outlet end, thereby controlling the diaphragm to open and close the cavity outlet to open and close the water path.

6. The pull-out faucet of claim 5, wherein the main valve and the guide valve of the pilot valve are arranged side by side and are coaxially provided on one side of the pull-out pipe which is movable up and down, and the guide valve is disposed more proximal to the pull-out pipe than the main valve; the pilot hole of the guide valve is located between a guide valve cavity of the guide valve and the right cavity, and a guide valve hole is formed between the guide valve cavity and the water outlet end; the movable plug is movable left and right in the guide valve cavity.

7. The pull-out faucet of claim 6, wherein the valve body of the non-electrically-driven water outlet assembly comprises a valve body seat and a valve body side cover which are side-by-side detachably connected to each other;
the left cavity and the right cavity of the main valve are formed between the valve body side cover and the valve body seat; a periphery of the diaphragm is fixed between the valve body side cover and the valve body seat; the left cavity is provided with a cavity inlet in communication with the water inlet end, and a middle part of the left cavity is provided with the cavity outlet in communication with the water outlet end; the valve body side cover is more proximal to the pull-out pipe than the valve body seat and is provided with the guide valve cavity;
an inner end of the movable plug is movable to open and close the pilot hole; an outer end of the movable plug more proximal to the pull-out pipe than the inner end is capable of being driven by a driving part of the driving mechanism so as to move the inner end of the movable plug.

8. The pull-out pipe of claim 5, wherein the main valve and the guide valve of the pilot valve are arranged in parallel in an up-down direction corresponding to a moving direction of the pull-out pipe in the pull-out faucet; the pilot hole of the guide valve is located between a guide valve cavity of the guide valve and the water outlet end, and a guide valve hole is formed between the guide valve cavity and the right cavity of the main valve; the movable plug is axially movable left and right in the guide valve cavity.

9. The pull-out faucet of claim 8, wherein the valve body of the non-electrically-driven water outlet assembly comprises a valve body seat, a valve body side cover, and a guide valve cover plate, where the valve body side cover and the guide valve cover plate are detachably connected side-by-side with the valve body seat;
the left cavity and the right cavity of the main valve are formed between the valve body side cover and the valve body seat; a periphery of the diaphragm is fixed between the valve body side cover and the valve body seat; the left cavity is provided with a cavity inlet in communication with the water inlet end, and a middle part of the left cavity is provided with the cavity outlet in communication with the water outlet end; the guide valve cover plate is located below the valve body side cover and adjacent to the pull-out pipe; the guide valve cavity is formed between the guide valve cover plate and the valve body seat;
an inner end of the movable plug is movable to open and close the pilot hole; an outer end of the movable plug more proximal to the pull-out pipe than the inner end is capable to be driven by a driving part of the driving mechanism so as to move the inner end of the movable plug.

10. The pull-out faucet of claim 7, wherein the outer end of the movable plug extends out of the valve body and faces to the pull-out pipe; the driving mechanism comprises said driving part radially protruding from the outer side wall of the pull-out pipe, and when the driving mechanism interacts with the movable plug, the driving part abuts against the movable plug to drive the movable plug to move into the valve body away from the pull-out pipe and thus open the water path;
the inner end of the movable plug passes through the guide valve and out of the pilot hole, and is provided with an inner limiting part radially protruding outwards around the inner end; a sealing plug capable of sealing the pilot hole is provided between the inner limiting part of the movable plug and the pilot hole; the guide valve cavity is provided with a movable plug opening facing towards the pull-out pipe; the outer end of the movable plug is movable in and out of the movable plug opening; a sealing ring is provided between the outer end of the movable plug and the movable plug opening sealing the movable plug opening when the outer end of the movable plug moves;
a movable plug elastic member is disposed between the movable plug and a stepped inner wall of the movable plug opening; the movable plug elastic member biases the movable plug such that the outer end of the movable plug extends out of the movable plug opening and the inner end of the movable plug seals the pilot hole.

11. The pull-out faucet of claim 9, wherein the outer end of the movable plug extends out of the valve body and faces to the pull-out pipe; the driving mechanism comprises said driving part radially protruding from the outer side wall of the pull-out pipe, and when the driving mechanism interacts with the movable plug, the driving part abuts against the movable plug to drive the movable plug to move into the valve body away from the pull-out pipe and thus open the water path;
the inner end of the movable plug passes through the guide valve and out of the pilot hole, and is provided with an inner limiting part radially protruding outwards around the inner end; a sealing plug capable of sealing the pilot hole is provided between the inner limiting part of the movable plug and the pilot hole; the guide valve cavity is provided with a movable plug opening facing towards the pull-out pipe; the outer end of the movable plug is movable in and out of the movable plug opening; a sealing ring is provided between the outer end of the movable plug and the movable plug opening sealing the movable plug opening when the outer end of the movable plug moves;
a movable plug elastic member is disposed between the movable plug and a stepped inner wall of the movable plug opening; the movable plug elastic member biases the movable plug such that the outer end of the movable plug extends out of the movable plug opening and the inner end of the movable plug seals the pilot hole.

12. The pull-out faucet of claim 9, wherein both the driving part and the movable plug are made of materials that magnetically attract each other; when the driving part approaches the movable plug, the driving part magnetically attracts the movable plug to move so that the movable plug moves to open the water path;
the movable plug is axially movable within the guide valve cavity; a sealing plug for sealing the pilot hole is provided on an outer side of the inner end of the movable plug; a movable plug elastic member is disposed between the outer end of the movable plug and an inner side wall of the guide valve cavity, and the movable plug elastic member biases the movable plug such that the inner end seals the pilot hole.

13. The pull-out faucet of claim 1, wherein the driving mechanism comprises a driving sleeve sleeved on the outer side wall of the pull-out pipe; the driving sleeve is driven by movement of the pull-out pipe to move up and down between a first position and a second position on one side of the non-electrically-driven water outlet assembly; one side of the driving sleeve is provided with a driving part that drives the movable plug to move; after the spray head resets to an original position on the faucet body, the pull-out pipe drives the driving part of the driving sleeve to move away from the movable plug, and thus therefore driving the driving sleeve to be located at the first position; when the spray head is pulled out from the faucet body, the pull-out pipe drives the driving part of the driving sleeve to move to a position that corresponds to the movable plug such that the driving part interacts with the movable plug, and thus therefore driving the driving sleeve to be located at the second position.

14. The pull-out faucet of claim 13, wherein a driving sleeve movement cavity is formed on said one side of the non-electrically-driven water outlet assembly;
the driving sleeve is movable up and down within a confinement defined by the driving sleeve movement cavity; a driving elastic member is arranged in the driving sleeve movement cavity; the driving sleeve and the driving part are biased upwards to be positioned corresponding to the movable plug under an elastic force of the driving elastic member; the pull-out pipe is movable up and down with respect to the driving sleeve; an annular projection limiting part is fixed on the outer side wall of the pull-out pipe; after the spray head resets onto the faucet body, the projection limiting part of the pull-out pipe is limited in the driving sleeve and abuts against the driving sleeve, and so the driving sleeve is driven by the projection limiting part of the pull-out pipe to overcome the elastic force of the driving elastic member and move away from the movable plug such that the driving sleeve is located at the first position; when the spray head is pulled out from the faucet body to an extent that the projection limiting part of the pull-out pipe moves away from the driving sleeve to an extent where the projection limiting part is no longer capable of driving the driving sleeve, the driving sleeve and the driving part thereon are still kept at the second position corresponding to the movable plug under the elastic force of the driving elastic member.

15. The pull-out faucet of claim 14, wherein an outer side surface of the projection limiting part is a convex curve that bulges outward in a middle part and tapers off at both upper and lower ends, and the widest part of the projection limiting part is abuttable with an inner wall of the driving sleeve.

16. The pull-out faucet of claim 15, wherein the movable plug is mounted in the valve body and movable in and out of the valve body; a movable plug elastic member is disposed between the movable plug and the valve body; the movable plug elastic member biases the movable plug to close the water path, an outer end of the movable plug is biased by the movable plug elastic member to extend out of the valve body facing to the pull-out pipe; the driving part is a projection radially protruding from an outer wall of the driving sleeve, and the projection moves along with the driving sleeve adjacent a side surface of the valve body; when the driving sleeve is moved to the second position, the projection abuts against the outer end of the movable plug so as to drive an inner end of the movable plug to open the water path.

17. The pull-out faucet of claim 13, wherein the movable plug is axially movable within the valve body; a movable plug elastic member is disposed between the movable plug and the valve body; the movable plug elastic part biases the movable plug to close the water path; both the driving part and the movable plug are made of materials that magnetically attract each other;
the driving part is a magnet protruding from an outer wall of the driving sleeve; when the driving sleeve is at the second position, the magnet magnetically attracts an outer end of the movable plug to drive the movable plug to move and thus open the water path.

18. The pull-out faucet of claim 17, wherein the magnet has a circular side wall, and an axial direction of the magnet corresponds to a movement direction of the movable plug; a shielding cover body is provided in a surrounding area of the magnet.

19. The pull-out faucet of claim 1, wherein the non-electrically-driven water outlet assembly is disposed at a valve seat of the faucet body, and being adjacent to one side of the pull-out pipe.
